(19) United States
(12) Patent Application Publication
(10) Pub. No.: US 2009/0112759 A1
(43) Pub. Date: Apr. 30, 2009

(54) ACCUMULATED TRANSACTIONS

(76) Inventor: Chuck Foster, Yountville, CA (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/929,430

(22) Filed: Oct. 30, 2007

(51) Int. Cl. G06Q 20/00; G06Q 40/00

(52) U.S. Cl. 705/40; 705/35; 705/39; 705/44

(57) ABSTRACT

A system and method of terminating a transaction between a merchant and customer are disclosed.

### BACKGROUND

1. Field

The subject matter disclosed herein related to transactions between a seller and a customer.

2. Information

Technological advances in financial services have enabled efficient non-cash transactions between merchants and customers. The evolution of credit cards and debit cards have enabled efficient payment for goods and/or services without the use of cash. In such non-cash transactions, a merchant typically receives information regarding a credit and/or debit card, which is then used to process payment with a financial institution that issues the credit and/or debit card. Additionally, the use of the Internet to process transactions between merchants and customers increasingly involves transmitting a customer's sensitive financial information over public networks. Accordingly, there is a desire to provide customers with additional protection from the risks of transmitting sensitive financial information over a public network such as the Internet.

### BRIEF DESCRIPTION OF THE FIGURES

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 is a schematic diagram of a transaction processing system according to an embodiment;

FIG. 2 is a flow diagram of a process facilitating non-cash transactions between a merchant and one or more customers;

FIG. 3 is a schematic diagram of a transaction processing system according to an alternative embodiment;

FIG. 4 is a flow diagram of a process facilitating non-cash transactions between a merchant and one or more customers;

FIG. 5 is a flow diagram illustrating a process for payment to a merchant on behalf of one or more customers according to an embodiment;

FIG. 6A is a flow diagram illustrating a process for payment to a merchant on behalf of one or more customers according to an alternative embodiment;

FIG. 6B is a schematic diagram of a transaction processing system according to an alternative embodiment;

FIG. 6C is a flow diagram illustrating a process for aggregating the cost of multiple purchases to be settled in a single payment according to an embodiment;

FIG. 7 is a schematic diagram of a system enabling completion of an expedited transaction according to an embodiment;

FIG. 8 is a schematic diagram of a system to process signals enabling completion of an expedited transaction according to an embodiment; and

FIG. 9 is a flow diagram illustrating a process enabling completion of an expedited transaction according to an embodiment.

### DETAILED DESCRIPTION

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions and/or information. Such storage devices may comprise any one of several media types including, for example, magnetic, optical or semiconductor storage media. However, these are merely examples of a storage medium and claimed subject matter is not limited in these respects.

Unless specifically stated otherwise, as apparent from the following discussion, it is appreciated that throughout this specification discussions utilizing terms such as “processing,” “computing,” “calculating,” “selecting,” “forming,” “enabling,” “inhibiting,” “terminating,” “downloading,” “identifying,” “initiating,” “querying,” “obtaining,” “hosting,” “maintaining,” “representing,” “modifying,” “receiving,” “transmitting,” “determining” and/or the like refer to the actions and/or processes that may be preformed by a computing platform, such as a computer or a similar electronic computing device, that manipulates and/or transforms data represented as physical electronic and/or magnetic quantities and/or other physical quantities within the computing platform's processors, memories, registers, and/or other information storage, transmission, reception and/or display devices. Such actions and/or processes may be executed by a computing platform under the control of machine-readable instructions stored in a storage medium. Further, unless specifically stated otherwise, process described herein, with reference to flow diagrams or otherwise, may also be executed and/or controlled, in whole or in part, by such a computing platform.

A “seller” as referred to herein relates to a party and/or entity that engages in transactions to provide goods and/or services in exchange for payment. In one embodiment, a seller may comprise a “merchant” that regularly engages in providing particular goods and/or services in exchange for payment as an on-going enterprise. Alternatively, a seller may comprise a private party which is willing to provide a good and/or service on a limited basis (e.g., a private party). However, these are merely examples of a seller and claimed subject matter is not limited in this respect.

A “customer” as referred to herein relates to a party and/or entity that engages in transactions with a seller to receive such goods and/or services in exchange for payment. For example, a seller may provide goods and/or services to one or more customers in exchange for payment from such customers in the form of cash payment, credit, account debit, barter exchange and/or the like. However, this is merely an example of how a seller and customer may engage in transactions for providing goods and/or services in exchange for payment, and claimed subject matter is not limited in these respects.

According to an embodiment, a seller may provide goods and/or services to a customer for non-cash payment. In particular examples, although claimed subject matter is not limited in these respects, such non-cash payment may be financed through credit that the customer has established with a merchant or a financial intermediary using, for example, a credit card. “Credit” refers to an amount of payment a merchant and/or financial intermediary is willing to receive from a customer as a non-cash payment. Such credit may quantify an allowable account balance which the customer promises to pay at a future date. Alternatively, such credit may comprise a cash balance that the customer has established a merchant and/or a financial intermediary using, for example, a debit card. However, these are merely examples of how a seller and customer may engage in a non-cash transaction for providing goods and/or services, and claimed subject matter is not limited in these respects.

According to an embodiment, a financial intermediary may assess a processing fee to a customer and/or merchant for the service of processing a non-cash transaction using credit. For example, a credit card company may charge a set fee for processing each transaction, regardless of the size of the transaction. As a portion of the value of a particular transaction, such a fee may be very costly in transactions for the purchase of low value goods and/or services.

According to an embodiment, although claimed subject matter is not limited in these respects, “completion” or “termination” of a financial transaction may occur upon any one of several events associated with such completion or termination of a financial transaction. In one embodiment, completion may occur upon tendering a good and/or service to a customer, payment of funds to a merchant or a confirmation (or promise) to a merchant that payment for a good and/or service is forthcoming. However, these are merely examples of events that may be used to define a completion of a transaction and claimed subject matter is not limited in these respects. In one embodiment, termination of a transaction may occur upon an event and/or condition that prevents completion of a transaction. For example, such a termination of a transaction may occur upon an event and/or condition that prevents payment to a merchant, notice of payment and/or delivery of goods and/or services. However, this is merely an example of a termination of a transaction and claimed subject matter is not limited in this respect.

According to particular embodiments described herein, financial transactions may be completed by transmitting information over data networks using any one of several communication protocols such as, for example, the Internet protocol and related communication protocols. For convenience, references to the Internet are used herein, but embodiments are equally applicable to any type of data network, and claimed subject matter is not limited in this respect. According to particular embodiments, although claimed subject matter is not limited in this respect, a transaction between a customer and merchant may be completed without transmission of a customer's sensitive information, such as credit card information and/or other personal financial information, over the Internet. In other embodiments, however, such sensitive information need not leave the possession of the customer to complete the transaction. Also, embodiments described herein may be suitable for use in any country and with any currency, since embodiments of the system allow financial institutions to effectuate currency exchange based on any existing exchange rates.

According to an embodiment, participants in a financial transaction system may comprise a seller, customer, and/or one or more financial intermediaries. While the following discussion illustrates interactions among such a seller, customer and a financial intermediary as a merchant, cardholder and card company, respectively, these are merely examples provided for illustration of a particular embodiment of a financial transaction system. Other financial transaction systems may facilitate interactions involving a customer that is not a cardholder, or a financial intermediary that is not a card company and/or a seller that is not a merchant, and claimed subject matter is not limited in this respect.

In transaction illustrated below, a merchant may comprise any party capable of providing a good and/or service to a customer as part of a credit and/or non-cash transaction. In one particular embodiment, although claimed subject matter is not limited in this respect, a merchant may provide and/or dispense cash to a customer in a transaction that is financed by a financial intermediary. For example, such a merchant may operate an automatic teller machine (ATM). Here, the good and/or service being purchased by a customer is cash. However, this is merely an example embodiment and claimed subject matter is not limited in this respect.

In transaction illustrated below, a merchant may comprise any party capable of providing a good and/or service to a customer as part of a credit and/or non-cash transaction. In one particular embodiment, although claimed subject matter is not limited in this respect, a merchant may provide and/or dispense cash to a customer in a transaction that is financed by a financial intermediary. For example, such a merchant may operate an automatic teller machine (ATM). Here, the good and/or service being purchased by a customer is cash. However, this is merely an example embodiment and claimed subject matter is not limited in this respect.

According to an embodiment, a card company may provide credit to a customer. For example, the card company may comprise a credit card company, a bank, a credit union, or other financial intermediary capable of facilitating credit card transactions. Such credit provided to a customer can be derived from any type of account, such as a credit card account, debit card account, a bank account, savings account, checking account or brokerage account. However, these are merely examples of how credit may be provided to a customer using particular types of accounts and claimed subject matter is not limited in these respects. Therefore, virtually any type of financial intermediary and/or financial intermediary can provide credit to the customer based on any type of account without deviating from claimed subject matter.

According to an embodiment, individuals comprising members of a family may be authorized as customers to make purchase on behalf of the family based upon their status in the family. Here, for example, a parent may be given unlimited authority while children may have limited purchasing authority to purchase only certain goods or make purchase only from specific merchants. However, these are merely examples of how a family purchasing policy may limit purchasing authority of children and claimed subject matter is not limited in this respect.

According to an embodiment, and as illustrated below with specific examples, a customer merchant and/or financial intermediary may be associated with a communication devices and/or computing platforms capable of communicating with one another over a data communication network. In a particular example, although claimed subject matter is not limited in this respect, customers may participate in non-cash transactions with a merchant by using a personal computer, cell phone, personal digital assistant, two-way pager and/or interactive television that receives user inputs from a remote control. However, these are merely examples devices that may enable a customer to participate in a non-cash transaction according to a particular embodiment and claimed subject matter is not limited in this respect.

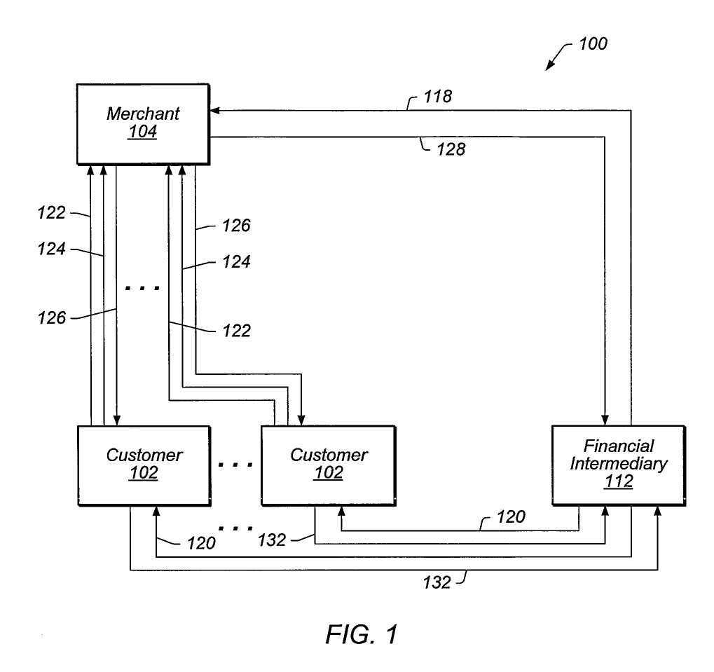

FIG. 1 is a schematic diagram of a transaction processing system 100 according to an embodiment. One or more customers 102 may purchase goods and/or services from merchant 104 using non-cash transactions which are financed by a financial intermediary 112 such as card company. Customers 102 may purchase goods and/or services from merchant 104 using any one of several methods such as, for example, on-line purchasing, phone orders, in-store purchasing, or any other methods discussed herein.

In a particular embodiment, although claim subject matter is not limited in this respect, customers 102 may be associated with computing platforms adapted to communicate with merchant 104 using an Internet Protocol (IP) infrastructure supported protocols as illustrated below. Accordingly, as referred to herein, the term “message” may relate to the transmission of information from a source to a destination using any one of several mediums such as, for example, a communication network such as the Internet and other IP infrastructure (e.g., email, HTTP, XML, etc.), dialup connection, facsimile transmission, person-to-person phone conversation, just to name a few. In the particularly illustrated embodiment, for example, a customer 102 may transmit a message 122 indicating a selection of a good and/or service for purchase using, for example, a web browser. Here, customer 102 may include information such as selections of a payment method, options, delivery terms and/or the like. In response, merchant 104 may transmit message 126 back to customer 102 indicating, for example, confirmation of a purchase, unavailability of the good and/or service selected for purchase, and/or the like.

As pointed out above, financial intermediary 112 may finance non-cash transactions between merchant 104 and customers 102. Here, financial intermediary 112 may receive a single invoice 128 to settle payment for multiple transactions between merchant 104 and customers 102. In response to invoice 128, financial intermediary 112 may make a single payment 118 for settlement. In one particular embodiment, although claimed subject matter is not limited in this respect, such a single payment 118 may comprise an electronic deposit of funds into a bank account held by merchant 104. Such an electronic deposit of funds may comprise, for example, a wire transfer or other type of electronic transfer employing IP infrastructure. Also, financial intermediary 112 may provide a billing statement 130 to a customer 102 for charges incurred on an associated credit account including, for example, a portion of invoice 118 attributed to transactions between merchant 104 and the customer 102.

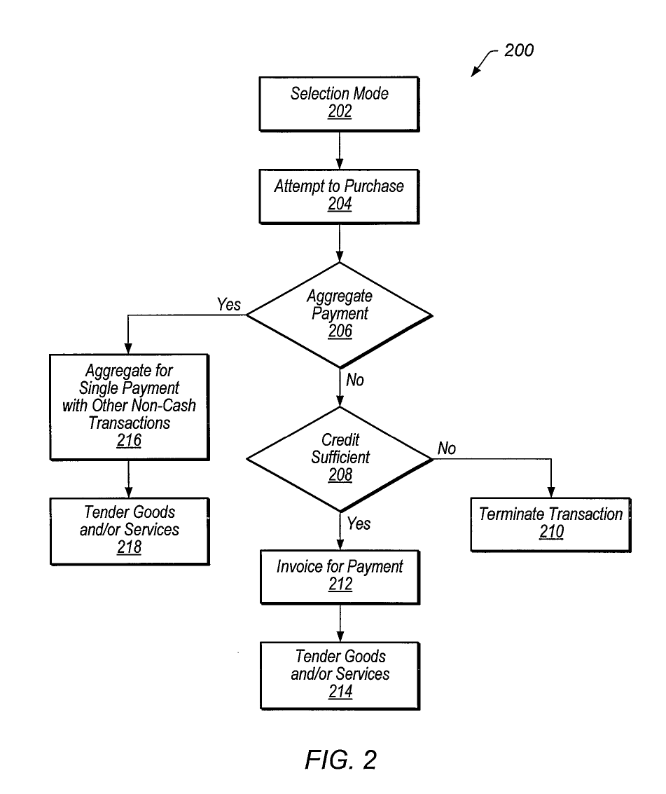

FIG. 2 is a flow diagram of a process 200 facilitating non-cash transactions between a merchant and one or more customers according to an embodiment of transaction processing system 100 illustrated with reference to FIG. 1. As illustrated above, such non-cash transactions may be carried out using any one of several methods such as, for example, using an on-line purchasing technique supported by IP infrastructure, in-store purchasing, phone order catalog and/or the like. Again, however, these are merely examples of how such a transaction for the purchase of a good and/or service may be carried out between a customer and a merchant, and claimed subject matter is not limited in these respects.

At block 202, a customer 102 may make a selection to purchase a good and/or service from merchant 104 by, for example, selecting the good and/or service for purchase on a website being operated by merchant 104, removing stock on shelves in a store, or selecting the good and/or service from a phone order catalog. At block 204, the customer 102 may then attempt to purchase the selected good and/or service by, for example, providing a credit number on a web browser and selecting a “pay” button, presenting the proposed transaction at an in-store check out counter with a credit card or providing credit card information over the phone. However, these are merely examples of how a customer may attempt to purchase a good and/or service using a non-cash transaction and claimed subject matter is not limited in these respects. According to an embodiment, such a credit card number presented to merchant 104 at block 104 may be associated with a credit account established with financial intermediary 112 on behalf of customer 102.

According to an embodiment, although claimed subject matter is not limited in this respect, financial intermediary 112 may charge merchant 104 a fee for processing non-cash transactions with customers 102 for payment. In a particular example, financial intermediary 112 may process such non-transactions individually and may charge a set fee for processing each individual transaction. Such a fee may be determined as, for example, a percentage of the value of the transaction or a set value for each non-cash transaction regardless of the value of the transaction. However, these are merely examples of such a set fee that a financial intermediary may charge for processing an individual non-cash transaction and claimed subject matter is not limited in these respects. Alternatively, for a single processing fee, financial intermediary 112 may process multiple, aggregated transactions involving one or more credit accounts established with financial intermediary 112 on behalf of one or more customers 102. Accordingly, by aggregating multiple transactions to be settled with a single payment, merchant 104 may pay a single processing fee that is less than a sum total of processing fees that would be charged by financial intermediary 112 if the multiple transactions were processed individually instead.

In response an attempt to purchase a good and/or service using a non-cash transaction at block 204, at diamond 206 merchant 104 may determine whether payment to settle such a non-cash should be aggregated with payment to settle other non-cash transactions financed by financial intermediary 112. Here, for example, merchant 104 may determine whether the non-cash transaction attempted at block 104 is to be aggregated, enabling payment to settle the aggregated transactions with a single payment from financial intermediary 112. In a particular embodiment, merchant 104 may determine whether such a non-cash transaction may be aggregated based, at least in part, on one or more of several factors such as, for example, the value of the non-cash transaction, mode of purchase (e.g., on-line, in store, phone order, business to business), time of purchase and risk factors associated with the customer 102 attempting the transaction (e.g., credit worthiness, status as an individual consumer or business, solvency, transaction history) and risk factors associated with financial intermediary 112 (e.g., payment history, solvency, payment terms offered). However, these are merely examples of factors that a merchant may evaluate in determining whether a non-cash transaction should be aggregated with other non-cash transactions to be settled with a single payment, and claimed subject matter is not limited in these respects.

If a non-cash transaction is not to be aggregated with other non-cash transactions, as determined at diamond 206, at diamond 208 merchant 104 may determine whether the customer 102 attempting the transaction has sufficient credit. Here, for example, merchant may determine whether the customer 102 has such sufficient credit by, for example, contacting financial intermediary 112, checking a fraud database, and/or the like. However, these are merely examples of how a merchant may determine whether a customer has sufficient credit to allow a non-cash transaction and claimed subject matter is not limited I these respects. If the customer does not have sufficient credit, merchant 104 may terminate the transaction at block 210 by, for example, informing the customer 102 that there is insufficient credit (e.g., at a store counter, using IP infrastructure, and/or the like). If the customer 102 has sufficient credit, merchant 104 may invoice the transaction for payment with financial intermediary 112 at block 212 and tender purchased goods and/or services at block 214.

If a non-cash transaction is to be aggregated, as determined at diamond 206, merchant 104 may aggregate the non-cash transaction with other transactions for a single invoice and payment at block 216 as illustrated below, and tender goods and/or services at block 218.

As illustrated above, a customer may establish an account with a financial intermediary to obtain credit which may be use to make financial transactions including, for example, purchase of goods and/or services, or payment of invoices. Such an account established by a customer may be associated with confidential personal information such as, for example, an account number and credit limit. According to an embodiment, a financial transaction system may eliminate any need for the transmission of such confidential information outside the control of the customer. As illustrated in U.S. Pat. No. 6,332,134 titled “Financial Transaction System,” one or more intermediaries may be involved in the processing of a non-cash transaction between a merchant and a customer in such a manner that the merchant does not need access to the customer's sensitive financial information and/or other personal information to complete the transaction. Here, a customer and a merchant may agree on terms of a proposed non-cash transaction to purchase a good and/or service to be financed through, for example, a credit card or debit card transaction. The customer may then forward information regarding the transaction to a financial intermediary (e.g., a credit card company). The financial intermediary may then forward a payment notification to the merchant to complete the non-cash transaction. The merchant may then provide the goods and/or services, and the financial intermediary and the customer may settle accounts following the purchase.

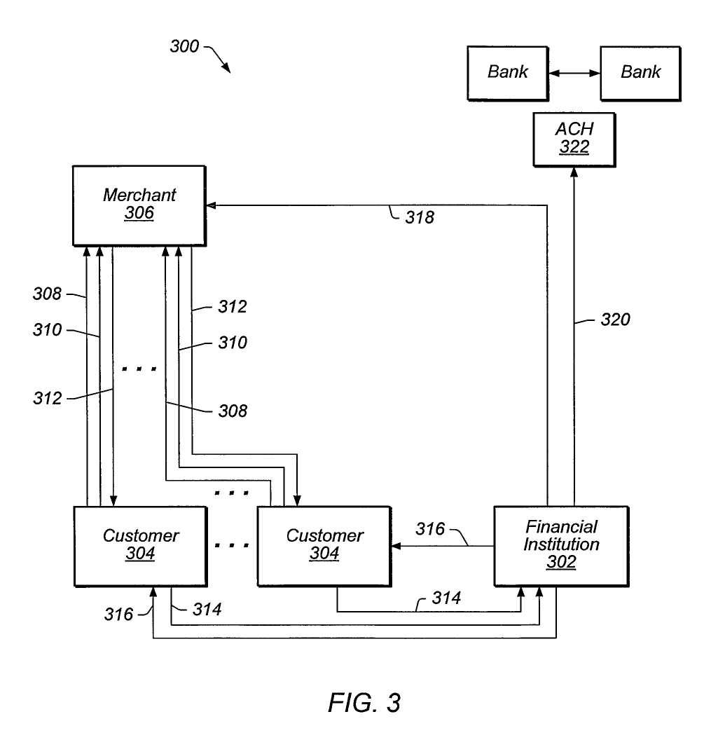

FIG. 3 is a schematic diagram of a financial transaction system 300 according to an embodiment. In a particular embodiment, although claimed subject matter is not limited in this respect, a financial intermediary 302, merchant 306 and one or more customers 304 may operate and/or control computing platforms that are capable of communicating with one another over a communication network such as the Internet, for example. Accordingly, as referred to herein, the term “message” may relate to the transmission of information from a source to a destination using any one of several mediums such as, for example, a communication network such as the Internet and other IP infrastructure (e.g., email, HTTP, XML, etc.), dialup connection, facsimile transmission, person-to-person phone conversation, just to name a few.

In a particular example, although claimed subject matter is not limited in this respect, a customer may participate in non-cash transactions with a merchant by using a personal computer, cell phone, personal digital assistant, two-way pager and/or interactive television that receives user inputs from a remote control. However, these are merely examples devices that may enable a customer to participate in a non-cash transaction according to a particular embodiment and claimed subject matter is not limited in this respect.

Financial intermediary 302 (or other credit provider) may provide software to a customer 304 to be loaded to customer's computing platform for implementing features of financial transaction system 300. This may allow a customer 304 to conduct financial transactions over the Internet or other data network, for example. Financial intermediary 302 may also authorize a merchant 306 to utilize financial transaction system 300 and issue software to merchant 306 for use in conjunction with merchant's interface to financial transaction system 306 including, for example, a website. Here, merchant 306 may agree to accept payment from financial intermediary 302 via an Automatic Clearing House (ACH) 322, which may perform bank to bank transfers for example. Once software is installed on computing platforms of a customer 304 and merchant 306, a financial transaction may be conducted as illustrated below. However, this is merely an example of how such transactions may be enabled according to a particular embodiment and claimed subject matter is not limited in this respect.

The description below illustrates interactions between a customer's computing platform and a merchant's computing platform as inputs provided by the customer to a graphical user interface (GUI) on customer's computing platform which are received at a website operated and/or controlled by the merchant according to an HTTP protocol. Alternatively, however, computing platforms operated and/or controlled by a merchant and a customer may employ any one of several techniques to communicate such as, for example, dial-up modem-to-modem communication over phone lines, a Web service, email and/or other protocols supported by the IP infrastructure. It should be understood, however, that these are merely examples, of how a customer's computing platform may communicate with a merchant's computing platform and claimed subject matter is not limited in this respect.

According to an embodiment, a customer 304 may register with financial transaction system 300 by contacting financial intermediary 302 and requesting that one or more of the customer's accounts be available for use in the financial transaction system 302. During such registration, a customer 304 may receive software to install on the customer's computing platform. Such software may contain, for example, code and/or information that can be recognized by a registered merchant's website that allows a purchase using financial transaction system 300. Such software may contain a changeable user password, a customer ID, a “Sales Log” database, dialing software, instructions, off-line catalog sites, and any miscellaneous promotions and/or data. A customer 304 may load such software on his or her computing platform and follow step by step instructions culminating in clicking on a “Register Now” button on a graphical user interface (GUI), for example. Executing the software, the computing platform may then contact financial intermediary 302 by, for example, dialing the financial intermediary's toll free number (e.g., using the computing platform's phone modem) or through other on-line means (e.g., Internet protocol over a broadband modem). Following such contact of financial intermediary 302, a registration process may be conducted. Here, according to a particular embodiment, a customer's ID and password may be checked against records maintained by financial intermediary 302. At registration, a different password may be chosen.

A customer 304 may provide an Order Verification Reply Target (OVRT) comprising information enabling financial intermediary 302 to address messages to the customer 304 comprising order confirmations or other information. Such an OVRT may comprise, for example, a telephone number to receive voice and/or facsimile communications, an e-mail address, Universal Resource Locator (URL), domain name and/or the like to which real-time communications may be addressed. It should be understood, however, that these are merely examples of information that may be used for addressing messages to a customer regarding a transaction and claimed subject matter is not limited in these respects. It may also be possible for the customer to register by voice over the telephone, fax or mail, however, installing computer software on customer's computing platform allows the customer to use financial transaction system 300 when making purchases over data networks, like the Internet.

Merchant 306 may register with financial intermediary 302 for authorization to accept payment for providing goods and/or services in transactions with customers 304. For example, the financial intermediary and merchant may agree to use ACH 322 to allow bank-to-bank transmission of funds to pay for merchant goods. Thus, an invoice from merchant 306 may be satisfied when financial intermediary 302 transfers funds to ACH 322 and then notifies merchant 306 of the transfer.

According to an embodiment, merchant 306 may also register with financial transaction system 300 by installing software to a computing platform for recognizing customers 304 browsing a website using software installed on a customer's computing platform identifying (as illustrated below) such customers 304 as being registered to financial transaction system 300. Upon such registration, merchant 306 may receive a database enabling processing of non-Internet orders from consumers using off-line catalogs. Also, merchant 306 may also receive unique identifier (ID) that is contained within the computer software installed to a computing platform operated by merchant 306. It should be understood, however, that these are merely examples of software that may be installed on a merchant's computing platform, and claimed subject matter is not limited in these respects.

As illustrated above, a customer 304 may provide an OVRT to enable financial intermediary 302 to notify customer 304 of the status of orders and/or other information. Here, for example, financial intermediary 302 may notify a customer 304 of a completion or termination of a transaction, and any problems that may have arisen in the course of the transaction, by associating the customer 304 with its OVRT. Such notification may be addressed according to the OVRT and may be in the form of an automated reply via email or other Internet protocol, fax and/or a voice message, for example. Merchant 306 may also be associated with an OVRT to receive information from financial intermediary 302 relating to customer purchases. In one particular embodiment, although claimed subject matter is not limited in these respects, such an OVRT may be associated with an Internet Protocol (IP) address and/or Internet domain name. Again, however, these are merely examples of how an OVRT may be implemented and claimed subject matter is not limited in these respects.

During registration of a customer 304, a shipping address for the customer 304 may be provided. Such a shipping address may indicate where items that are purchased by the customer 304 are to be shipped. This can be different from a billing address for customer 304. Such a billing address may indicate where financial intermediary 302 may send bills relating to a credit account established on behalf of the customer 304. According to an embodiment, financial transaction system 300 may allow, by use of authentication using a password and User ID for example, one or more alternative addresses to be used for specific purchases. This may overcome a problem of having a billing address that is different from the shipping address. For example, a P.O. Box may be used, or some other temporary address, so that a customer may purchase airline tickets while traveling or when making a purchase to send to another address as a gift.

According to an embodiment, a history of purchases made by a customer using a financial transaction system may be maintained in a database stored on a computing platform operated by the customer. This may allow such a customer the convenience of determining information about what has been purchased, vender, price, etc. Also, the data may be maintained in a format (e.g., data fields separated by tab or comma) that may be exportable to record keeping software such as Quicken, Excel, FileMaker Pro or any program that accepts data in such a format.

As discussed above, customers 304 and merchant 306 may register to obtain an ID and password to be used in participating in financial transaction system 300. Software installed on a computing platform operated by a customer 304 may operate in conjunction with well known web browser programs to allow the customer 304 to browse the Internet and make purchases using financial transaction system 300. Such installed software may include one or more of the following modules and/or items of information:

plugins covering typical operating systems and browsers;

registration routine (as illustrated above);

routine for maintaining database logging purchases for the customer's use;

instructions for registration;

dialing string software for initial registration to a direct toll free line;

IP address, URL and/or domain name for use in contacting financial intermediary for registration;

offline website/catalogs featuring financial intermediary merchants;

credit card application for the financial intermediary;

applications to register with shipping companies; and

browser(s) which is adapted to dial direct any of the selected merchants via a toll free offline number.

In an alternative to using a web browser to communicate with merchant 306 and/or financial intermediary 302, a customer 304 may employ other techniques for facilitating transactions over a data network such as employing a Web service. Such a Web service may integrate application programs hosted by merchant 306, a customer 304 and/or financial intermediary 302 using an IP infrastructure. In particular examples, although claimed subject matter is not limited in these respects, such a Web service may employ standard communication protocols to transmit data objects among component applications over an Internet protocol such as, for example, HTTP, HTTPS, XML, SOAP, WSDL and/or UDDI standards. Here, XML may be used to tag data objects, SOAP may be used to transfer data objects, WSDL may be used to describe available services and UDDI may be used to list available services. However, these are merely examples of protocols that may enable a Web service and claimed subject matter is not limited in these respects.

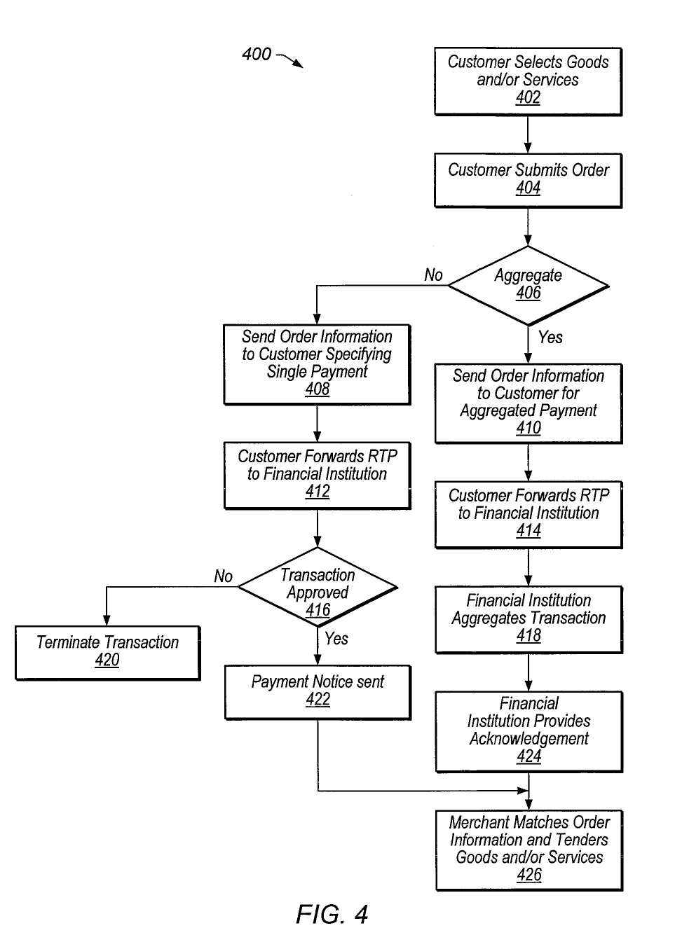

FIG. 4 is a flow diagram illustrating a process 400 of conducting a financial transaction using financial transaction system 300, for example, to enable secure financial transactions among customer 304, merchant 306 and financial intermediary 302. At block 402, a customer 304 may select a good and/or service for purchase from merchant 306 by interacting with using messages 308 to communicate with a computing platform operated by and/or on behalf of merchant 306. Here, in a particular example, customer 304 may make such a selection by browsing the Internet using a web browser program installed on a computing platform. In one embodiment, as pointed out above, this may be enabled by a plug-in for such a web browser program.

At block 404, a customer 304, after making a selection of a good and/or service for purchase, may communicate with a merchant's computing platform using message 310 to submit an order for the purchase of the selected good and/or service at block 404 using a non-cash transaction. Upon receiving an order submitted at block 404, merchant 306 may determine whether payment for completing such a non-cash transaction should be aggregated with payment for completion of one or more other non-cash transactions. As illustrated above, such a determination may be based, at least in part, on any one of several factors such as the value of the non-cash transaction, mode of purchase (e.g., on-line, in store, phone order, business to business), time of purchase and risk factors associated with the customer 102 attempting the transaction (e.g., credit worthiness, status as an individual consumer or business, solvency, transaction history) and risk factors associated with financial intermediary 302 (e.g., payment history, solvency, payment terms offered). However, these are merely examples of factors that a merchant may evaluate in determining whether a non-cash transaction should be aggregated with other non-cash transactions to be settled with a single payment, and claimed subject matter is not limited in these respects.

If merchant 306 determines at diamond 406 that payment to settle a non-cash transaction is not to be aggregated with payment to settle other non-cash transactions, process 400 may continue processing the non-cash transaction in a manner similar to processes illustrated in the aforementioned U.S. Pat. No. 6,332,134. Here, at block 408 merchant 306 may send order information in a message 312 specifying that the non-cash transaction is to be settled with financial intermediary with a single payment. Upon receipt of message 312 specifying the single payment, a customer 304 may forward a request to pay (RTP) to financial intermediary 302 in a message 314. Such an RTP may include information such as, for example, purchase order data received from merchant 306 in message 312 and a unique ID and password associated with customer 304.

At diamond 416, financial intermediary 302 may allow or terminate a non-cash transaction based, at least in part, on any one of several factors. Here, according to a particular embodiment, financial intermediary 302 may perform one or more tests. For example, financial intermediary 302 may determine whether customer 304 is allowed to make the requested purchase by, for example, determining whether customer 304 has sufficient credit to pay for the selected good and/or service. Also, financial intermediary 302 may determine whether merchant 306 allowed to participate in this non-cash transaction by, for example, determining whether merchant 306 is a registered merchant in good standing. However, these are merely examples of how a financial intermediary may determine whether a non-cash transaction is to be approved and claimed subject matter is not limited in these respects.

If financial intermediary 302 does not approve a non-cash transaction at diamond 416, financial intermediary may terminate the non-cash transaction at block 420 by, for example, sending a termination message to a customer 304 in a message 316. Otherwise, if financial intermediary 302 approves a non-cash transaction at diamond 416, financial intermediary may provide a notice of payment to merchant 306 in a message 318. Such a notice of payment may include, for example, order information identifying the transaction initiated by a customer 304 (e.g., selected goods and/or services) and information indicating an intent to make payment to merchant 306 via ACH 322. At block 426, merchant 306 may then match order information from message 318 with a previous order and tenders selected goods and/or services to customer 304. In an alternative embodiment, the merchant may not have access to address information associated with a destination of a customer's purchased goods. Here, a shipping party (not shown) may merely receive goods from the merchant with order information. The shipping party may then associated the order information with location to deliver the purchased goods.

If merchant 306 determines at diamond 406 that payment to settle a non-cash transaction is to be aggregated with payment to settle other non-cash transactions, merchant 306 may transmit order information to a customer 304 in a message 312 associated with goods and/or services selected for purchase and an indication that payment to settle the non-cash transaction is to be aggregated. At block 414, customer 304 may then forward an RTP in a message 314 to financial intermediary 302 including, for example, order information in message 312 and an indication that payment is to be aggregated. At block 418, financial intermediary 302 may update an account of aggregated transactions to be settled with a single payment to merchant 306 based, at least in part, on a value of the goods and/or services indicated in order information of the RTP in message 314. At block 424, financial intermediary 302 may provide an acknowledgement in a message 324 to merchant 306 indicating receipt of order information from customer 304 and aggregation of payment. In response to message 324, merchant 306 may then match order information from message 324 as illustrated above and tender goods and/or services.

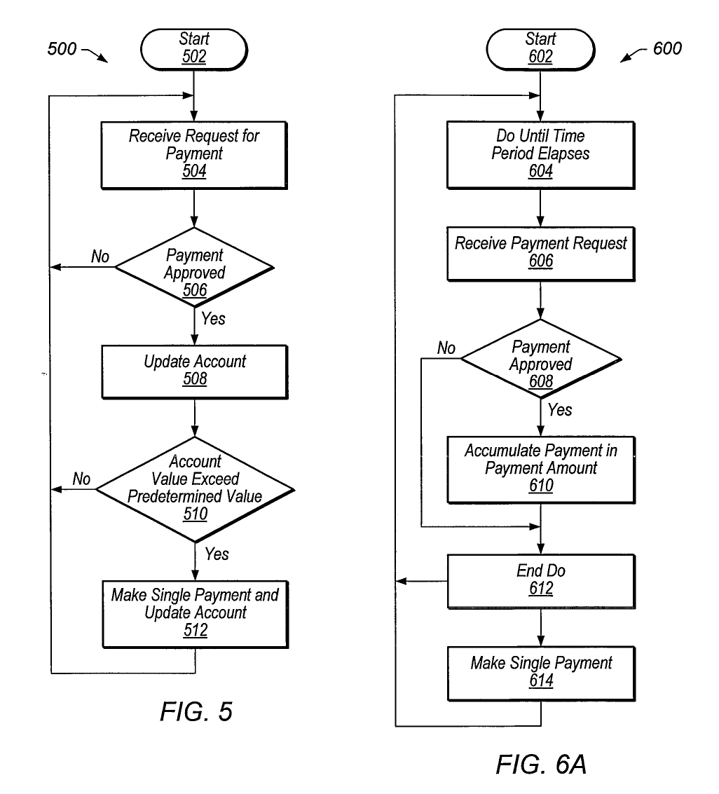

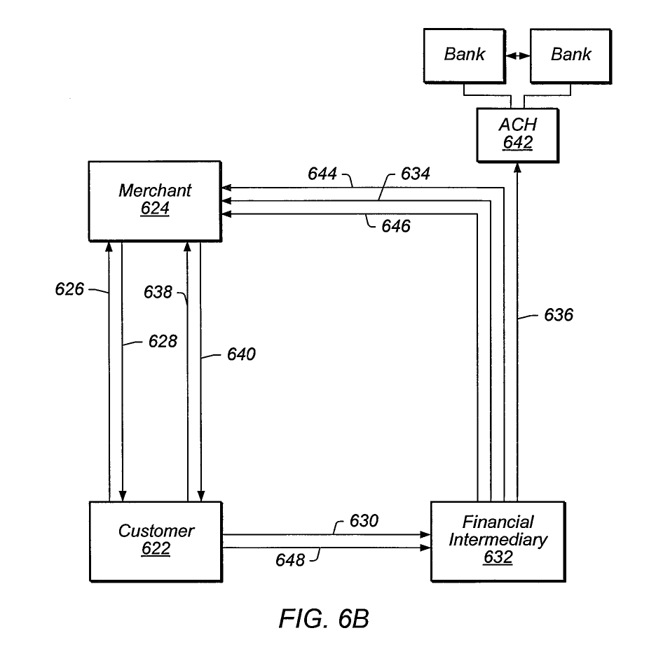

As illustrated above in connection with specific embodiments, a financial intermediary may aggregate payment to settle multiple non-cash transactions involving a merchant in a single payment. In one particular example, as illustrated in FIG. 5, a financial intermediary may aggregate payment for multiple transactions until the aggregated payment meets or exceeds a predetermined value. In another example, as illustrated in FIG. 6, a financial intermediary may aggregate payment for multiple transactions over a predetermined period. However, these are merely examples of how a financial intermediary may aggregate payment to a merchant for settlement of multiple non-cash transactions in a single payment and claimed subject matter is not limited in this respect.

FIG. 5 is a flow diagram illustrating a process 500 to aggregate payment for multiple transactions until the aggregated payment meets or exceeds a predetermined value. Such a process may be performed by, for example, one or more computing platforms on behalf of a financial intermediary such as financial intermediary 112 or 302. Here, a financial intermediary may receive a request for payment at block 504 from, for example, a customer or merchant as illustrated above. The financial intermediary may approve payment based, at least in part, one or more of the value of the (e.g., in-store purchase, on-line, phone order, etc.) and credit risk associated with a customer initiating the transaction. However, these are merely examples of factors which a financial intermediary may evaluate when determining whether to finance a non-cash transaction and claimed subject matter is not limited in this respect.

If a financial intermediary approves payment at diamond 506, an account associated with a merchant may be updated at block 508 to include, for example, a value of a non-cash transaction identified in a request for payment received at block 504. If the updated account value exceeds predetermined value as determined at diamond 510, a financial intermediary may make a single payment to the merchant at block 512 to settle multiple non-cash transactions aggregated at block 508 and update the account associated with the merchant accordingly. However, this is merely an example of how a financial intermediary may aggregate payment to a merchant for settling multiple non-cash transactions and claimed subject matter is not limited in this respect.

FIG. 6A is a flow diagram illustrating a process 600 for payment to a merchant for settling multiple non-cash transactions over a predetermined period. Again, such a process may be performed by, for example, one or more computing platforms on behalf of a financial intermediary such as financial intermediary 112 or 302. Here, process 600 may iterate blocks 604 through 612 until a predetermined period elapses. Such a predetermined period may comprise, for example, billing cycle (e.g., daily, weekly, monthly or annually). Block 606 receives a payment request and, subject to approval of the payment at diamond 608 considering factors as illustrated above, block 610 updates a payment account to include, for example, a value of a non-cash transaction identified in the payment request. At the end of the time period, a single payment may be made at block 614 to settle multiple non-cash transactions conducted during the time period.

FIG. 6B is a schematic diagram of a transaction processing system according to an embodiment. Here, merchant 624 may use a policy code to determine whether a purchase price of a transaction initiated by customer 622 is to be aggregated with the purchase price of other transactions for payment in a single lump sum, for example. Such a policy code may have multiple fields defining, for example, a total amount that may be aggregate over multiple transactions until merchant 624 will require payment. In a particular implementation, such a policy code may have a format of “XXX/YYY/ZZZ/WWW” where “XXX” represents a single purchase limit and/or aggregation limit and “YYY” represents a time period during which a customer is expected to make a minimum total purchase value. The field may “ZZZ” represent a minimum total purchase value of items purchased over the time period specified in YYY. Finally, the field “WWW” may represent an amount that is owed the merchant if the customer does not may purchases meeting or exceeding ZZZ in the period YYY.

In a particular numerical example, provided for the purpose of illustration, policy code XXX/YYY/ZZZ/WWW may represent 100/30/50/5, indicating a maximum purchase price and/or aggregation of $100, a $50 minimum aggregate value for items purchased over a 30 day period and a $5 fee charged if the customer does not make purchases for an aggregate value of at least $50 over the 30 day period.

According to an embodiment, customer 622 may transmit message 626 to merchant 624 to, for example, select an item for purchase using one or more of the techniques described above. In response, merchant 624 may transmit message 628 containing, for example, information identifying merchant 624, an OVRT, an invoice identifier and items purchased to date and/or over a time period. Message 628 may also comprise a policy code determining whether payment for the item selected in message 626 is to be aggregated with payment to settle one or more other purchases from merchant 624 in a single payment, for example. Customer 622 and merchant 624 may exchange information subsequent to placement of an order in messages 638 and 640 to, for example, redirecting a shipping address, change options with respect to the item(s) purchased that do not affect net payment amount and/or the like.

Upon receipt of message 628, customer may forward all or a portion of the information in message 628 (e.g., including a policy code determining whether payment is to be aggregated) to financial intermediary 632 in a message 630. Here, financial intermediary may determine whether payment for purchase of an item selected through message 626 is to be aggregated with payment to settle other purchasing transactions between customer 622 and merchant 624. As illustrated above according to particular embodiments, financial intermediary 632 may initiate payment (e.g., for settling one or more purchasing transactions between merchant and customer) by transmitting message 636 to instruct ACH 642 to initiate an exchange of funds between banks of merchant 624 and customer 622. Upon initiating such payment, financial intermediary 632 may also transmit message 634 to merchant 624, addressed according to an OVRT received in message 630 from customer 622, providing notification of payment of funds to merchant 624. Such a notification in message 634 may include, for example, one or more invoice or transaction identifiers associating the payment amount with items purchased.

If payment for a transaction is to be aggregated with payment for other transactions, financial intermediary 632 may update a running account between customer 622 and merchant 624 by updating an account of amount owed by customer 622 to merchant 624. Financial intermediary 632 may also transmit a message 644 to merchant 624 acknowledging receipt of the payment request from customer 622 for the particular transaction (e.g., identified by an invoice number). Upon receipt of either message 634 notifying merchant 624 of payment or message 644 acknowledging receipt of a payment request and aggregation of an associated purchase price, merchant 624 may allow a transaction to complete as illustrated above. To the extent that there are changes to payment terms (e.g., amounts paid) to settle a transaction (e.g., as indicated by a subsequent message 640 from merchant 624 indicating additional payment required or the unavailability of an item ordered), customer 622 may transmit subsequent instructions in message 648 to inform financial intermediary 632 of the change. Financial intermediary 632 may then provide a subsequent acknowledgment of the change in message 646 to merchant 624.

FIG. 6C is a flow diagram illustrating a process 650 for aggregating the cost of multiple purchases to be settled in a single payment according to an embodiment. In a particular embodiment, process 650 may be executed by financial intermediary 632 in response to a request for payment received in message 630 from customer 622, for example. In response to receipt of such a payment request, diamond 654 may determine whether the purchase price exceeds a single transaction limit. In the particular example above, such a single transaction limit may be determined from information in a policy code received in message 630 (e.g., as specified in field XXX). Similarly, diamond 656 may determine whether the amount of the payment request 652 combined with amounts to settle payment for any previous unsettled transactions exceeds an aggregate limit. If either of the single transaction or aggregate limits are exceeded, block 658 may initiate payment (e.g., through a message 636) to a merchant for any unsettled transactions (e.g., including the amount of the payment request 652 and any previous unsettled transactions) and block 662 may send a payment notification for any associated transactions to a the merchant (e.g., through a message 105). Otherwise, if payment of the amount to settle the transaction is to be aggregated with other payments, block 660 may aggregate such an amount with unpaid amounts for settling one or more other transactions (e.g., by updating a customer's account with a merchant) and block 664 may send an acknowledgment of the aggregated payment to an affected merchant to allow the transaction to complete.

According to an embodiment, customers may purchase goods and/or services in stores where values associated with such transactions may vary from a very small or diminimis value to a relatively high value. Regardless of a value of a good and/or service available for purchase in a store however, processes for purchasing a relatively expensive item or a relatively inexpensive item are typically substantially the same. However, a seller's risk to financing a non-cash purchase of an inexpensive good and/or service (e.g., risk of customer's non-payment) may be significantly smaller than a seller's risk to financing a non-cash purchase of an expensive good and/or service.

Under certain conditions, according to a particular embodiment, a customer may be permitted to complete an “expedited transaction” to purchase a good and/or service from a merchant. Here, a merchant may employ a procedure to facilitate sale of goods and/or services to customers. An expedited transaction may comprise a process by which a customer may purchase a good and/or service using an alternative procedure. In a retail store, such as a department store or grocery store for example, customers may queue up to a check-out counter to purchase goods and/or services to provide cash and/or credit information for goods and/or services. In one embodiment, although claimed subject matter is not limited in this respect, a customer may purchase a good and/or service in such a retail store using an expedited transaction that avoids use of such a check-out counter. However, this is merely an example of an expedited transaction and claimed subject matter is not limited in this respect.

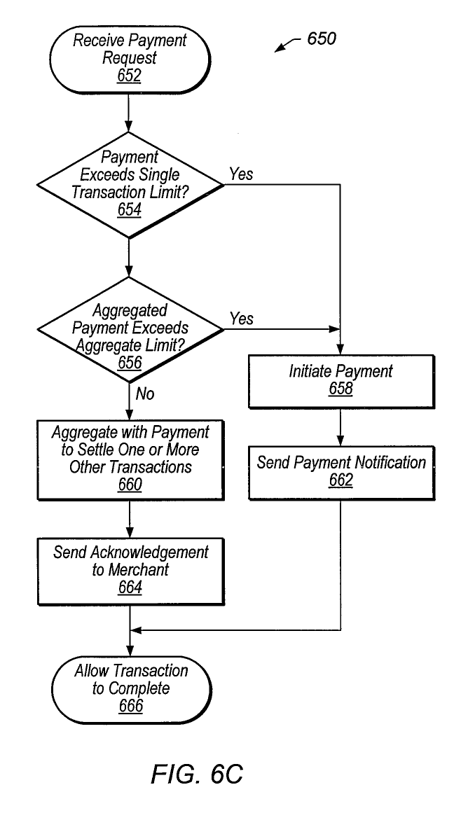

FIG. 7 is a schematic diagram of a system 700 to enable completion of an expedited transaction according to a particular embodiment. System 700 may be provided in a retail establishment that enables customers (not shown) to purchase goods and/or services from a check-out counter (not shown). A first transmitter 702 may be located on or about customer while a second transmitter 704 may be located on or about an article that is available for purchase by the customer. In a particular embodiment, although claimed subject matter is not limited in this respect, transmitters 702 and 704 may comprise small radio frequency identification (RFID) devices capable of transmitting information encoded in a radio frequency (RF) signal. Transmitter 702 may comprise, for example, an RFID device worn on a customer's clothing, attached to a key chain or embedded in the customer's person. Here, transmitter 702 may transmit an RF signal encoding information that identifies or is otherwise associated with the customer. Transmitter 704 may comprise, for example, an RFID device formed on a product label, product packaging or otherwise attached and/or affixed to an article available for purchase. Here, transmitter 704 may transmit an RF signal encoding information that identifies or is otherwise associated with the article.

According to an embodiment transmitters 702 and 704 may each transmit an RF signal from a single point or location defined in three dimensions, for example. By processing signals received from transmitters 702 and 704 using techniques known to those of ordinary skill in the art it may be determined with transmitters 702 and 704 are co-located. According to an embodiment, antennas 706 located about a zone 714 may receive RF signals transmitted from transmitters 702 and 704. In one embodiment, RF signals received at antennas 706 may then be used to determine a distance “d” between transmitters 702 and 704 (e.g., a Euclidian distance) using techniques known to those of ordinary skill in the art. Here, according to a particular embodiment, detecting a distance “d” smaller than a given threshold distance may indicate that transmitters 702 and 704 are co-located. Alternatively, transmitters 702 and 704 may be determined to be co-located if both are detected as being present in a particular area or space. It should be understood, however, that these are merely examples techniques that may be used in determining whether transmitting devices are co-located and claimed subject matter is not limited in this respect.

In one embodiment, although claimed subject matter is not limited in this respect, presence of transmitters 702 and 704 in zone 714 may indicate an intent of a customer carrying transmitter 702 to purchase an article to which transmitter 704 is attached. Also, RF signals received at antennas 706 from transmitter 702 may be decoded to provide information identifying or is otherwise associated with a customer carrying transmitter 702. Similarly, RF signals received at antennas 706 from transmitter 704 may be decoded to provide information identifying or is otherwise associated with an article to which transmitter 704 is attached. Here, information associated with a customer, as decoded from an RF signal received from transmitter 702, and information associated with an article, as decoded from an RF signal received from transmitter 704, may be used to determine whether the customer is authorized to make an expedited purchase of the article. In system 700, in a particular example, such an expedited transaction may comprise enabling the customer to pass between barriers 712 and across threshold 708 on direction 710 without having to complete a transaction at a check-out counter. Here, for example, such a path along direction 710 may comprise an exit from a retail store that allows customers to make expedited purchases under certain conditions. As illustrated below, information associated with the customer and article (e.g., obtained from decoding RF signals received from transmitters 702 and 704 as illustrated above) may be used to conduct a non-cash transaction for completing an expedited purchase. However, this merely an example of an expedited transaction and claimed subject matter is not limited in this respect.

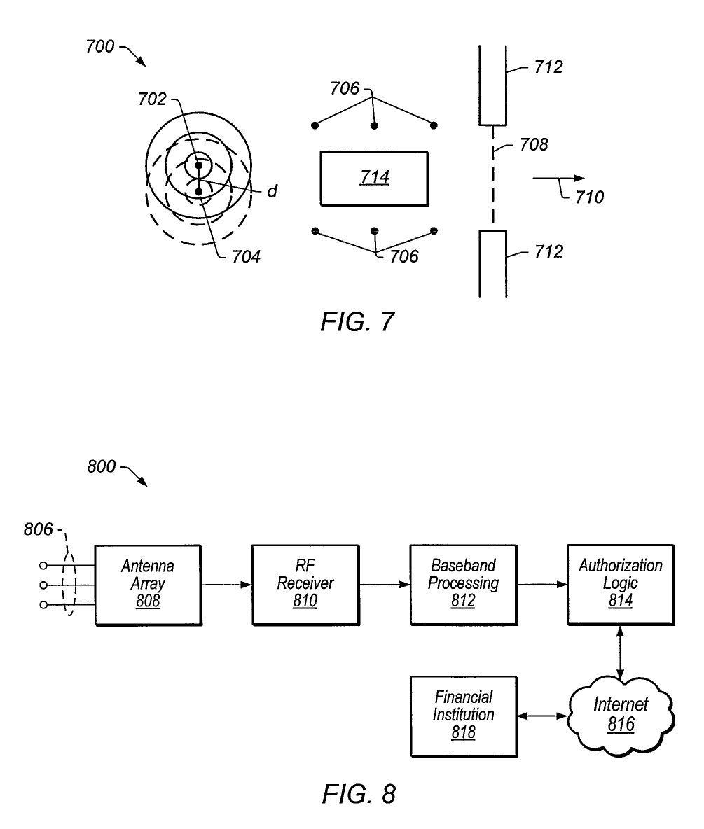

According to an embodiment, system 700 may employ system 800 shown in FIG. 8 to process signals received at antennas 706 and enable completion of an expedited transaction as illustrated above. A receiver 810 may process RF signals received at an antenna array 808 by, for example converting the received signals from an RF format to a baseband format. Baseband processing block 812 may then decode the baseband signals to obtain information such as, for example, information identifying or otherwise associated with a customer or an article for purchase as illustrated above. In addition, baseband processing 812 may also comprise logic to determine whether devices are co-located using one or more of the techniques identified above, for example.

According to a particular embodiment, upon obtaining information identifying or otherwise associated with a customer and article available for purchase from baseband processing 812, authorization logic 814 may determine whether an expedited transaction may be allowed to complete. Authorization logic 814 may comprise, for example, a computing platform comprising a network adapter (not shown) to transmit data to and receive data from Internet 816 according to any one of the aforementioned protocols for communicating with financial intermediary 818.

In a particular embodiment, although claimed subject matter is not limited in this respect, authorization logic 818 may obtain credit information associated with customer to determine whether the customer is authorized to complete an expedited purchase of an article, for example. Also, authorization logic 814 may communicate with financial intermediary 818 for settlement of non-cash transactions such as expedited purchases. In a particular embodiment, although claimed subject matter is not limited in this respect, computing platforms associated with financial intermediary 818 and authorization logic 814 may host applications that are part of a web service as described above. However, this is merely an example of how authorization logic may communicate with a financial intermediary over IP infrastructure and claimed subject matter is not limited in this respect.

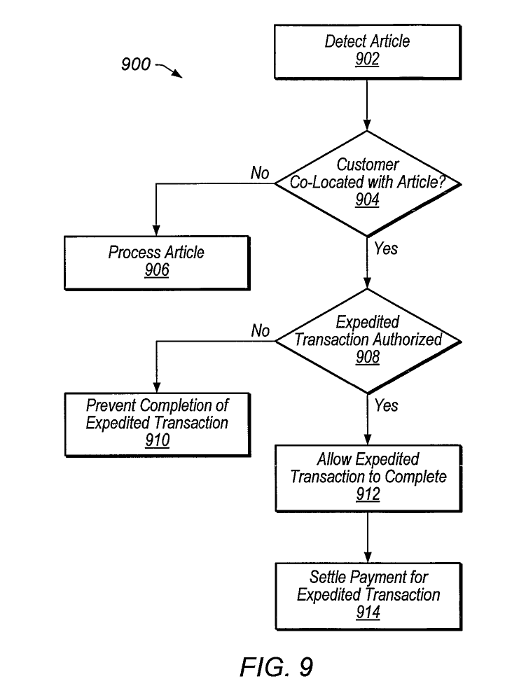

According to a particular embodiment, although claimed subject matter is not limited in this respect, authorization logic 814 may implement a process 900 as shown in FIG. 9 to enable completion of an expedited transaction. Block 902 may detect a presence of an article in a location. According to a particular embodiment illustrated above with reference to FIG. 7, block 902 may detect a presence of transmitter 704 in zone 714 based, at least in part, on RF signals received from transmitter 704 at antennas 706. However, this merely an example of how a presence of an article may be detected according to a particular embodiment and claimed subject matter is not limited in this respect.

Diamond 904 may determine whether the article detected at block 902 is co-located with a customer detected. In the particular embodiment illustrated in FIG. 9, diamond 904 determines whether a customer and article are co-located in response to detecting a presence of an article. In alternative embodiments, however, a determination that a customer and article are co-located may be made in response to detecting a presence of a customer instead of determining a presence of an article.

If diamond 904 determines that an article and customer are not co-located, block 906 may process the article. In a retail sales establishment, according to a particular embodiment, it may be concluded that the article is loose and needs to be placed on stock shelves. However, this merely an example of how an article may be processed in response to determining that the article is not co-located with a customer and claimed subject matter is not limited in this respect.

If a customer and article are determined to be co-located, diamond 908 may determine whether an expedited transaction may be authorized based, at least in part, on one or more pieces of information. Here, diamond 908 may determine whether an expedited transaction is authorized based upon, for example, one or more of a retail price and/or value associated with the article, time of day, credit information associated with a customer. Referring to the example of FIG. 8, such information may be obtained by authorization logic 814 via a connection to information sources coupled to Internet 816. For example, authorization logic 814 may be capable of obtaining credit information associated with a customer by querying an information source such as financial intermediary 818. However, this merely an example of a source of information that may provide credit information associated with a customer and claimed subject matter is not limited in this respect.

If an expedited transaction is not authorized, as determined at diamond 908, block 910 may prevent such an expedited transaction from being completed. Referring to the example of system 700 according to a particular embodiment, this may entail preventing a customer from passing beyond zone 714 on path 710. This may include, for example, preventing a customer from passing through a gate (not shown) between barriers 712 and/or a sounding of an alarm as a customer attempts to move along path 710 as part of an expedited transaction. However, these are merely examples of how an expedited transaction may be prevented from completion according to particular embodiments, and claimed subject matter is not limited in these respects.

If an expedited transaction is authorized, as determined at diamond 908, block 912 may allow such an expedited to complete. Referring again to the particular example of system 700, this may entail allowing a customer to pass beyond zone 714 on path 710 by, for example, allowing the customer to pass through a gate (not shown) between barriers 712. However, this is merely an example of how an expedited transaction may be allowed to complete according to a particular embodiment and claimed subject matter is not limited in this respect.

Following completion of an expedited transaction at block 912, payment for the non-cash transaction may be settled at block 914. Referring to the particular embodiment of system 800 in FIG. 8, for example, such payment may be settled through communications with financial intermediary 818 using one or more of the techniques illustrated above for settling payment of non-cash transactions.

While there has been illustrated and described what are presently considered to be example embodiments, it will be understood by those skilled in the art that various other modifications may be made, and equivalents may be substituted, without departing from the claimed subject matter. Additionally, many modifications may be made to adapt a particular situation to the teachings of the claimed subject matter without departing from the central concept described herein. Therefore, it is intended that the claimed subject matter not be limited to the particular embodiments disclosed, but that the such claimed subject matter may also include all embodiments falling within the scope of the appended claims, and equivalents thereof.

1-11. (canceled)

12. A method comprising:
receiving a first radio frequency signal from an article;
receiving a second radio frequency signal from a customer;
determining whether said article and said customer are co-located based, at least in part, on said first and second radio frequency signals; and
selectively enabling completion of a non-cash transaction to purchase said article based, at least in part, on at least one of said first and/or second radio frequency signals.

13. The method of claim 12, wherein said selectively enabling completion of said transaction further comprises determining whether said customer is authorized to complete an expedited transaction to purchase said article.

14. The method of claim 13, wherein said determining whether said customer is authorized to complete said expedited transaction further comprises:
associating information in said second radio signal with an account associated with said customer; and
determining whether said customer is authorized to complete said expedited purchase base, at least in part, on information associated with said account.

15. The method of claim 14, wherein said information associated with said account comprises an account balance.

16. The method of claim 12, and further comprising associating said first radio signal with a price associated with said article, and wherein said selectively enabling said completion of said transaction further comprises selectively enabling said completion based, at least in part, on said price.

17. The method of claim 16, and further comprising associating information in said second radio signal with an account associated with said customer, and wherein said selectively enabling completion of said transaction further comprises selectively enabling said completion based, at least in part, on information associated with said account.

18-28. (canceled)

29. A apparatus comprising:
means for receiving a first radio frequency signal from an article;
means for receiving a second radio frequency signal from a customer;
means for determining whether said article and said customer are co-located based, at least in part, on said first and second radio frequency signals; and
means for selectively enabling completion of a non-cash transaction to purchase said article based, at least in part, on at least one of said first and/or second radio frequency signals.

30. The apparatus of claim 29, wherein said means for selectively enabling completion of said transaction further comprises means for determining whether said customer is authorized to complete an expedited transaction to purchase said article.

31. The apparatus of claim 30, wherein said means for determining whether said customer is authorized to complete said expedited transaction further comprises:
means for associating information in said second radio signal with an account associated with said customer; and
means for determining whether said customer is authorized to complete said expedited purchase base, at least in part, on information associated with said account.

32. The apparatus of claim 31, wherein said information associated with said account comprises an account balance.

33. The apparatus of claim 29, and further comprising means for associating said first radio signal with a price associated with said article, and wherein said means for selectively enabling said completion of said transaction further comprises means for selectively enabling said completion based, at least in part, on said price.

34. The apparatus of claim 33, and further comprising means for associating information in said second radio signal with an account associated with said customer, and wherein said means for selectively enabling completion of said transaction further comprises means for selectively enabling said completion based, at least in part, on information associated with said account.

35-44. (canceled)

45. A system comprising:
one or more radio receivers configured to receive a first radio frequency signal from an article and a second radio frequency signal from a customer; and
a computing platform, said computing platform being adapted to:
determine whether said article and said customer are co-located based, at least in part, on said received first and second radio frequency signals; and
selectively enable completion of a non-cash transaction to purchase said article based, at least in part, on information in at least one of said first and/or second radio frequency signals.

46. The system of claim 45, wherein said computing platform is adapted to selectively enable completion of said transaction in response to determining whether said customer is authorized to complete an expedited transaction to purchase said article.

47. The system of claim 46, wherein said determining whether said customer is authorized to complete said expedited transaction further comprises:
associating information in said second radio signal with an account associated with said customer; and
determining whether said customer is authorized to complete said expedited purchase base, at least in part, on information associated with said account.

48. The system of claim 47, wherein said information associated with said account comprises an account balance.

49. The system of claim 45, and wherein said computing platform is further adapted to:
associate information in said first radio signal with a price associated with said article; and
selectively enabling said completion based, at least in part, on said price.

50. The system of claim 49, wherein said computing platform is further adapted to:
associate information in said second radio signal with an account associated with said customer; and
selectively enable said completion based, at least in part, on information associated with said account.

51-55. (canceled)

56. The method of claim 12, wherein said determining includes:
using the first and second radio frequency signals to determine a distance between the article and the customer; and
determining that the article and the customer are co-located based upon the distance being less than a given threshold distance.

57. The method of claim 12, wherein said determining includes:
using the first and second radio frequency signals to determine respective locations of the article and the customer;
determining that the article and the customer are co-located based upon the respective locations both being within a particular area or space.
